(19) United States
(12) Patent Application Publication
(10) Pub. No.: US 2026/0028822 A1
(43) Pub. Date: Jan. 29, 2026

(54) ROOF SURFACE CLEANING APPARATUS

(71) Applicant: Adam Marsh, Forest Lake, MN (US)

(72) Inventor: Adam Marsh, Forest Lake, MN (US)

(21) Appl. No.: 19/099,361

(22) PCT Filed: Jul. 28, 2023
(86) PCT No.: PCT/US2023/071221

§ 371 Date: Jan. 28, 2025

Related U.S. Application Data
(60) Provisional application No. 63/393,122, filed on Jul. 28, 2022.

(51) Int. Cl. E04D 15/00; B08B 1/16; B08B 1/30; B08B 1/40; B08B 3/02; B08B 5/04; B25G 1/04; E04D 13/076

(52) U.S. Cl. CPC E04D 15/006; B08B 1/165; B08B 1/30; B08B 1/40; B08B 3/024; B08B 5/04; B25G 1/04; E04D 13/0765

(57) ABSTRACT

A surface cleaning apparatus includes an elongated pole having a longitudinal axis extending along an end portion remote from an opposite end held by a user. A first surface engaging utensil and a second surface engaging utensil each are joined to the end portion. Each of the surface engaging utensils extend radially with respect to the longitudinal axis from the end portion. At least one of the surface engaging utensils is rotatable about the longitudinal axis and is adjustably fixable at any one of a plurality of different angular positions with respect to the end portion.

### CROSS-REFERENCE TO RELATED APPLICATION

This Application is a Section 371 National Stage Application of International Application No. PCT/US2023/071221, filed Jul. 28, 2023 and published as WO 2024/026461 A1 on Feb. 1, 2024 and further claims priority to U.S. Provisional Application No. 63/393,122, filed Jul. 28, 2022.

### BACKGROUND

The discussion below is merely provided for general background information and is not intended to be used as an aid in determining the scope of the claimed subject matter.

Aspects of the invention relate to an apparatus and method for cleaning surfaces, and in particular to a method and apparatus of cleaning surfaces of a building roof whereupon debris matter accumulates. In particular, tree debris accumulates in valleys formed between pitched sections of the roof as well as in gutters. In addition to tree debris, moss can also grow on some roofs and it is desirable to remove it from time to time. Likewise, snow can also accumulate and it is beneficial to remove it due to its weight and increased likelihood of creating ice dams.

An apparatus that can address one or more of the material that falls upon or accumulates on a roof of other surface would be desirable.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A surface cleaning apparatus includes an elongated pole having a longitudinal axis extending along an end portion remote from an opposite end held by a user. A first surface engaging utensil and a second surface engaging utensil each are joined to the end portion. Each of the surface engaging utensils extend radially with respect to the longitudinal axis from the end portion. At least one of the surface engaging utensils is rotatable about the longitudinal axis and is adjustably fixable at any one of a plurality of different angular positions with respect to the end portion.

In one embodiment, each of the first surface engaging utensil and the second surface engaging utensil includes a first radially extending edge portion and a second radially extending edge portion on a side opposite the first radially extending edge portion, wherein the at least one of the first surface engaging utensil and the second surface engaging utensil is rotatable about the longitudinal axis so as to selectively orient the first surface engaging utensil and the second surface engaging utensils in a first V-shape and a second V-shape, wherein in the first V-shape, the first radially extending edge portions face toward each other forming an inner acute angle, and wherein in the second V-shape, the second radially extending edge portions face toward each other forming the inner acute angle. At least one of the first surface engaging utensil and the second surface engaging utensil can include one or more strips, foams, and/or bristles proximate the pole that extend to form an apex in the first V-shape. The one or more strips, foams, and/or bristles of the first surface engaging utensil and the second surface engaging utensil can form a substantially continuous length of the one or more strips, foams, and/or bristles along the first surface engaging utensil, through the apex and along the second surface engaging utensil. If desired, the substantially continuous length of the one or more strips, foams, and/or bristles along the first surface engaging utensil, through the apex and along the second surface engaging utensil is provided for a plurality of V-shapes with different acute angles between the first surface engaging utensil and the second surface engaging utensil. This allows the apparatus to be configured to the shape of the structure to be cleaned.

The first radially extending edge portions are flexible, for example, made from one or more flexible strips, foams, and/or bristles, while if desired, the second radially extending edge portions can comprise a rigid scraper. If desired, a glide or wheel is attached to the scraper to space apart the second radially extending edge from a surface upon which the glide or wheel engages. If desired, the first surface engaging utensil is identical to the second surface engaging utensil, which reduces manufacturing costs.

In a further embodiment, the at least one of the first surface engaging utensil and the second surface engaging utensil is rotatable such that in a first position the first radially extending edge portions are selectively fixed adjacent to and substantially parallel to each other, and in a second position the second radially extending edge portions are selectively fixed adjacent to and substantially parallel to each other.

In yet a further embodiment, a pole-based lock is operable between the at least one of the first surface engaging utensil and the second surface engaging utensil and the end portion to hold the at least one of the first surface engaging utensil and the second surface engaging utensil in selected angular positions with respect to the end portion, alternatively or in addition, a utensil lock is operable between the first surface engaging utensil and the second surface engaging utensil to hold the at least one of the first surface engaging utensil and the second surface engaging utensil in selected angular positions with respect to the end portion.

In one embodiment, the end portion is removable from another portion of the pole. In one embodiment, each pole-based lock can comprise a depressible button located on the end portion, whereas each utensil lock can comprise complementary mating surfaces formed on the first surface engaging utensil and the second surface engaging utensil.

Various attachments can be provided to address other cleaning functions. For instance, at least one nozzle can be joined to at least one of the first surface engaging utensil and the second surface engaging utensil. The nozzle is connected to a sprayer with a fluid line coupled at a first end to the at least one nozzle and coupled to the sprayer at a second end. This attachment allows cleaning or other fluids to be conveniently applied. If desired, a pair of nozzles are provided wherein a nozzle is joined to each of the first surface engaging utensil and the second surface engaging utensil.

Another form of attachment comprises a vacuum system to clean gutters and the like. The vacuum system includes a vacuum nozzle joined to at least one of the end portion, the first surface engaging utensil and the second surface engaging utensil and a vacuum line connected to the vacuum nozzle. At an end opposite the vacuum nozzle, a vacuum pump is connected to the vacuum line to collect debris obtained from the vacuum nozzle.

### BRIEF DESCRIPTION OF THE DRAWINGS

FIG. 1 is a perspective view of a surface cleaning apparatus.

FIG. 2 is an exploded view of the surface cleaning apparatus.

FIG. 3 is a sectional view of a locking mechanism.

FIG. 4 is a perspective view of a first surface engaging utensil.

FIG. 5 is a side elevation view of the first surface engaging utensil.

FIG. 6A-6D are perspective views of the surface cleaning apparatus in various positions.

FIG. 7 is a perspective view of a second embodiment of a surface cleaning apparatus with a second embodiment of a locking mechanism.

FIGS. 8A and 8B are partial perspective views of the second embodiment of a surface cleaning apparatus in different positions.

FIG. 9 is a perspective view of a surface engaging utensil of the second embodiment of the surface cleaning apparatus.

FIG. 10 is a partial perspective view of the second embodiment of the surface cleaning apparatus.

FIG. 11 is a partial perspective view of the second embodiment of the surface cleaning apparatus.

FIG. 12 is a perspective view of a third embodiment of a surface cleaning apparatus with a third embodiment of a locking mechanism.

FIG. 13 is sectional view of a portion of the third embodiment of a locking mechanism.

FIG. 14A is a perspective view of the surface cleaning apparatus with spacing members.

FIG. 14B is a front elevational view of the surface cleaning apparatus with spacing members.

FIG. 14C is a perspective view of the surface cleaning apparatus with spacing members.

FIG. 15 is a perspective view of a surface engaging utensil with a spacing member.

FIG. 16 is a perspective view of the surface cleaning apparatus configured to clean a valley.

FIG. 17 is a perspective view of the surface cleaning apparatus configured to clean a flat roof having shingles or tiles with a brush.

FIG. 18 is a perspective view of the surface cleaning apparatus configured to clean a flat roof with a scraper.

FIG. 19 is a perspective view of the surface cleaning apparatus configured to clean a gutter.

FIG. 20 is a perspective view of the surface cleaning apparatus configured to clean a flat, for example, steel roof.

FIG. 21 is a perspective view of the surface cleaning apparatus configured to clean a soffit.

FIG. 22 is a perspective view of the surface cleaning apparatus configured to clean a soffit and siding.

FIG. 23 is a perspective view of a surface cleaning apparatus with a spray nozzle assembly.

FIG. 24 is a perspective view of a spray nozzle.

FIG. 25 is a perspective view of the surface cleaning apparatus with spray nozzle assembly and a fluid pump.

FIG. 26 is a perspective view of a surface cleaning apparatus with a gutter vacuum attachment.

FIG. 27 is a perspective view of a support for the gutter vacuum attachment.

FIG. 28 is a first perspective view of a gutter and the surface cleaning apparatus having the gutter vacuum attachment.

FIG. 29 is a second perspective view of the gutter and the surface cleaning apparatus having the gutter vacuum attachment.

FIG. 30 is a third perspective view of the gutter and the surface cleaning apparatus having the gutter vacuum attachment.

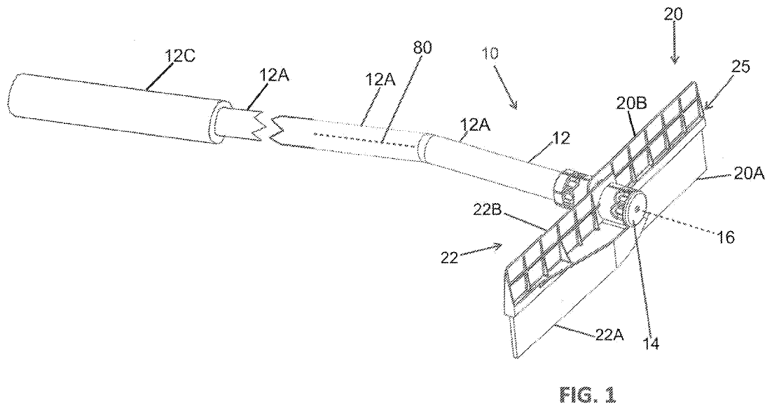

### DETAILED DESCRIPTION OF THE ILLUSTRATIVE EMBODIMENTS

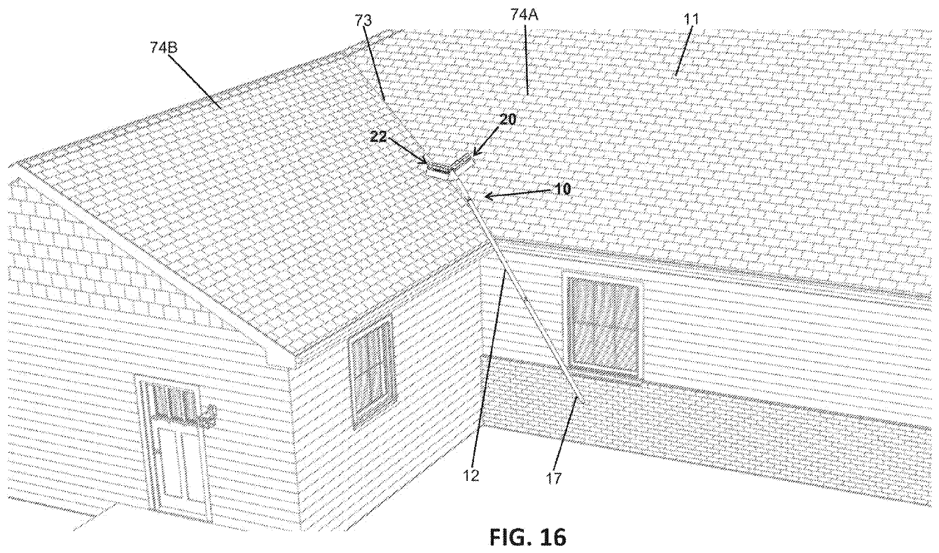

A surface cleaning apparatus 10 particularly well suited for cleaning a roof such as but not limited to a roof is illustrated at 11 in FIG. 16. The surface cleaning apparatus includes an elongated pole 12 having a longitudinal axis 16 extending along an end portion 14 remote from an opposite end 17 (FIG. 16) held by a user. The elongated pole 12 can comprise a plurality of tube sections 12A joined successively together to form a desired length. One or more tube sections 12A can comprise telescoping sections if desired. One or more tube sections 12A can include a soft exterior covering 12C such as made from foam or the like. These tube sections 12A can be placed anywhere along the length of the pole so as to protect damage to structures such as gutters, facia or the like, and/or disposed at the end of the pole 12 to aid the user when holding the pole 12.

A first surface engaging utensil 20 and a second surface engaging utensil 22 each are joined to the end portion 14. Each of the surface engaging utensils 20, 22 extend radially with respect to the longitudinal axis 16 from the end portion 14. At least one of the surface engaging utensils 20, 22 is rotatable about the longitudinal axis 16 and is adjustably fixable at any one of a plurality of different angular positions with respect to the end portion 14. Although not required, preferably, the surface engaging utensils 20, 22 are identical to each other which minimizes the number of unique components in the assembly.

Each of the surface engaging utensil 20 and the second surface engaging utensil 22 includes a first radially extending edge portion 20A, 22A and a second radially extending edge portion 20B, 22B on a side opposite the first radially extending edge portion 20A, 22A. As indicated above at least one of the first surface engaging utensil 20 and the second surface engaging utensil 22 is rotatable about the longitudinal axis 16. This allows the surface engaging utensils 20, 22 to be selectively orientated with respect to each other.

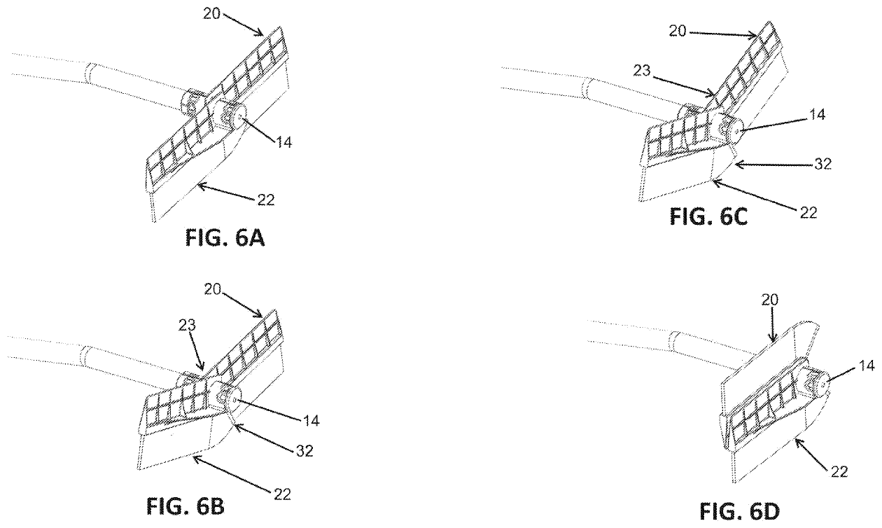

FIGS. 6A-6D illustrate exemplary orientations of utensils 20, 22. FIG. 6A illustrates the surface engaging utensils 20, 22 in a flat orientation where the surface engaging utensils 20, 22 extend in opposite directions to each other. FIGS. 6B and 6C illustrate two different V-shapes that can be obtained with the surface engaging utensils 20, 22, while FIG. 6D illustrates surface engaging utensil 20A disposed directly above surface engaging utensil 22. When disposed in a V-shape, the surface engaging utensils 20, 22 have portions that generally face toward each other so as to form an inner acute angle 23. In a preferred embodiment, each surface engaging utensil 20, 22 includes rigid and/or flexible portions. In the embodiment illustrated, extending edge portions 20A, 22A are flexible, while extending edge portions 20B, 22B are rigid In FIGS. 6B and 6C it is illustrated that the inner acute angle 23 is formed between the second radially extending edge portions 20B, 22B; however, this should not be considered limiting in that if desired, at least one of the surface engaging utensils 20, 22 can be rotated to form an inner acute angle between the first radially extending edge portions 20A, 22A as illustrated in FIGS. 14A-14C.

In the embodiment illustrated, each surface engaging utensil 20, 22 includes the flexible extending edges 20A, 22A and rigid radially extending edges 20B, 22B; however, this should not be considered limiting. Each surface engaging utensil 20, 22 includes at least one radially extending edge and these edges may or may not be the same. Likewise, if desired, one surface engaging utensil may have two radially extending edges while the other only has one radially extending edge. The flexible radially extending edges 20A, 22A can be formed from any suitable material such as but not limited to a flexible strip, an edge having a plurality of flexible segmented strips, or extending bristles. If provided with a rigid radially extending edge such as illustrated at 20B, 22B, the edge typically forms a scraper. Various forms of reinforcing members 25 can be included so as to maintain the rigidity of the radially extending edges 20B, 22B.

In one embodiment, it may be helpful that the rigid radially extending edges 20B, 22B do not contact the surface along its longitudinal length, but rather, it may be desirable to space it apart from the surface to be cleaned. For example, such spacing may be preferable so as not to remove rocks that are present on asphalt shingles. In FIGS. 14A-14C and 15, a spacing member 30 is located on each of the utensils 20, 22 and extends slightly beyond the radially extending edges 20B, 22B so as to space the edges 20B, 22B from the surface to be cleaned. In the embodiment illustrated, the spacing member 30 comprises a rotatable wheel supported herein by successive reinforcement members 25. In another embodiment, the spacing member can be a glide that does not rotate but is configured so as to gently slide upon the surface to be cleaned. If desired, the spacing member 30 can be removable when it is desired that the radially extending edges 20B or 22B contact the surface to be cleaned. One or both utensils 20, 22 may have two or more spacing members 30, being for example wheels(s) and/or glide(s), if desired

Referring to FIGS. 4 and 5, the first radially extending edge portions 20A, 22A have end portions 31 proximate the longitudinal axis 16 that are configured so as to extend a generally a fixed radial distance with respect to the longitudinal axis 16 or collar 49 about an angular range. The portions 31 form an apex 32 in each of the V-shapes illustrated in FIGS. 6B and 6C, although other angular displacements can also be obtained. With the end portions 31 so configured, a substantially continuous edge is obtained in any of the V-shape orientations of the surface engaging utensils 20, 22. Although there is a slight axially offset between the radially extending edges 20A, 22A, there is a substantially continuous line from one remote end of the surface engaging utensil 20 to the opposite end of the surface engaging utensil 22. In a particularly advantageous embodiment, the surface engaging utensils 20, 22 have extending bristles such that a V-shape brush is obtained having the apex 32.

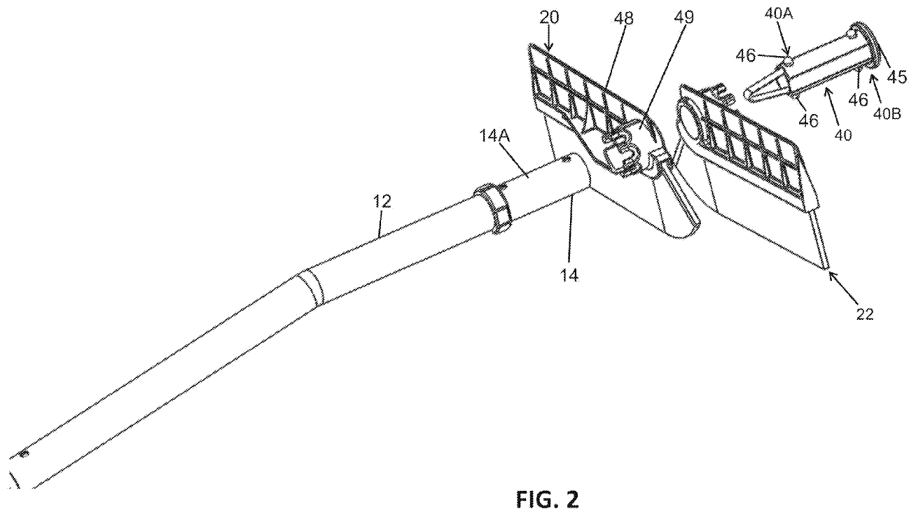

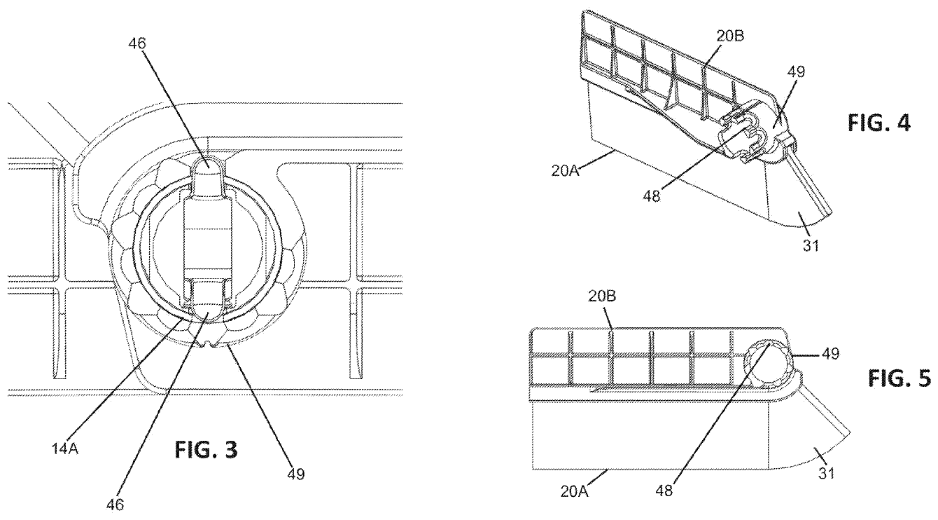

Various forms of locking mechanisms can be used to selectively fix the angular position of one or both of the surface engaging utensils 20, 22 with respect to the pole 12, end portion 1 or longitudinal axis 16. In FIG. 2 a pole-based lock 40 is operable between at least one of the surface engaging utensils 20, 22 and the end portion 14 to hold the one or both of the surface engaging utensils 20, 22 in the selected angular position with respect to the end portion 14. The pole-based lock 40 can include movable members 46 herein illustrated as depressible buttons that can be located in one of two positions. Referring to FIG. 3, the movable member 46 can extend beyond the cylindrical sleeve 14A of the end portion 14 so as to engage a corresponding recess 48 formed in a collar 49 of at least one of the surface engaging utensils 20, 22 and thereby inhibit any rotation of the collar 49 and associated utensil 20, 22 on end portion 14. In a second position of the movable member 46, it is at the same level as the cylindrical sleeve 14A of the end portion, or slightly below the cylindrical surface 14A such that the collar 49 can rotate freely upon the cylindrical end portion 14. Each collar 49 includes a plurality of recesses 48 formed about the perimeter thereof so as to allow the movable member 46 to extend therein and lock and thereby inhibit rotation of the collar 49 and the associated utensil 20, 22. Commonly, the movable members 46 are operated successively until the desired rotational position of the utensil 20, 22 is obtained. In the embodiment illustrated in FIGS. 2 and 3, a plurality of movable members 46 are provided for each surface engaging utensil 20, 22. Herein the movable members 46 extend in opposite directions and are oriented so as to be 180 degrees apart from each other. Although the collar 49 and recesses 48 can be configured such that each of the movable members 46 will engage a corresponding recess 48 in each of the selected angular positions, in a further embodiment, the recesses 48 are disposed about the collar 49 such that only one movable member 46 will engage a recess 48 in any of the selected angular positions. This is illustrated in FIG. 3, where the upper movable member 46 engages a recess 48, while the lower movable member 46 is at or below the cylindrical surface 14A because it is not aligned with a recess 48. Configured in this manner, more recesses 48 can be disposed about the collar 49 at smaller angular intervals so as to allow a finer adjustment of the angular position of the surface engaging utensil 20 or 22. For instance, with respect to FIG. 3, the recesses 48 are disposed such that the next locked angular position will occur when the lower movable member 46 engages a recess 48 while the upper movable member 46 is no longer in the recess 48 shown but instead is at or below the cylindrical surface 14A because it is not aligned with a recess 48.

Referring back to FIG. 2, in the exemplary embodiment, the movable members 46 are provided on a plug 45 that can be inserted into the end portion 14. In the embodiment illustrated, two sets of movable members 46 are provided. A first set 40A is used to fix the angular position of the surface engaging utensil 20 while a second set 40B are used to engage the recesses 48 of the surface engaging utensil 22. By having the movable members 46 on the plug 45, each of the surface engaging utensils 20 and 22 can be easily positioned on the end portion 14 since the movable members 46 do not extend through the apertures provided in the end portion 14 until the plug 45 is inserted into the end portion 14.

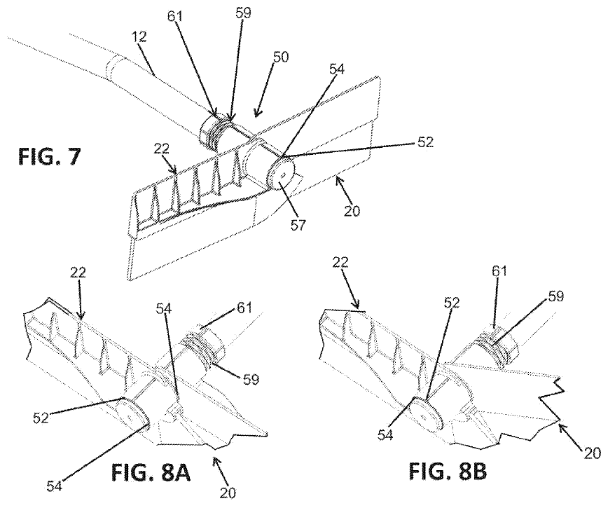

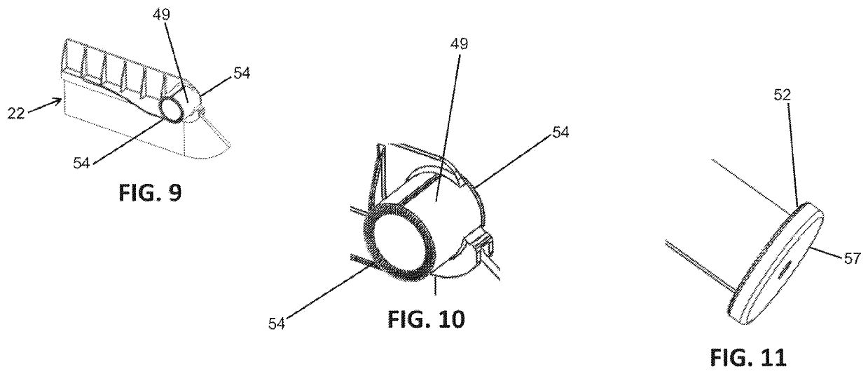

FIGS. 7-11 illustrate another form of lock 50. The lock 50 interlocks the surface engaging utensils 20, 22 together at a selected angular position rather than locking the angular position of each surface engaging utensil 20, 22 to the end portion 14 as illustrated with the lock 40. The lock 50 inhibits rotation by complimentary surfaces 54 of each of the surface engaging utensils 20, 22 engaging each other. In the embodiment illustrated, each end of the collar 49 of the surface engaging utensils 20, 22 has projections and recesses 54 that mate with each other when the surface engaging utensils 20, 22 are disposed adjacent to each other on the end portion 14 such as illustrated in FIGS. 7, 8A and 8B. For instance the projections and recesses of each complimentary surface can be similar to teeth of a ring gear Although the lock 50 can interlock the surface engaging utensils 20, 22 together, at least one of the utensils 20, 22 must be angularly fixed with respect to the end portion 14. For example, the lock 40 in the prior embodiment can be used so as to provide a movable member that engages a recess 48 provided in the collar 49. In the embodiment of FIG. 7-11, a plug 57 has an end with inwardly facing projections and recesses 52 that engage the complimentary recesses and projections 54 provided on the other end the collar 49 of the surface engaging utensil that is not engaged with the other surface engaging utensil. The plug 57 can be held in a stationary position with respect to the pole 14 in any suitable matter such as with a fastener or with a movable member 46 described above.

Referring to FIGS. 7, 8A and 8B, a spring 59 is provided on the end portion 14 herein remote from the plug 57. One end of the spring 59 engages a fixed stop herein a collar 61 while the other end of the spring 59 engages the collar 49 of the surface engaging utensil 20. The spring 59 provides a force that urges the surface engaging utensils 20, 22 to lock together at lock 50 while also urging the surface engaging utensil 22 to engage the complimentary surface 52 formed on the plug 57. By pulling the surface engaging utensil 20 toward the fixed stop 61 so as to compress the spring 59, the complimentary surfaces of lock 50 and the complimentary surfaces of plug 57 and surface engaging utensil 22 are released allowing the user to adjust the angular position of the utensils 20, 22. When the surface engaging utensil 20 is released the spring 59 forces the surface engaging utensils 20, 22 together and the surface engaging utensil 22 against the plug 57 so as to fix their angular positions.

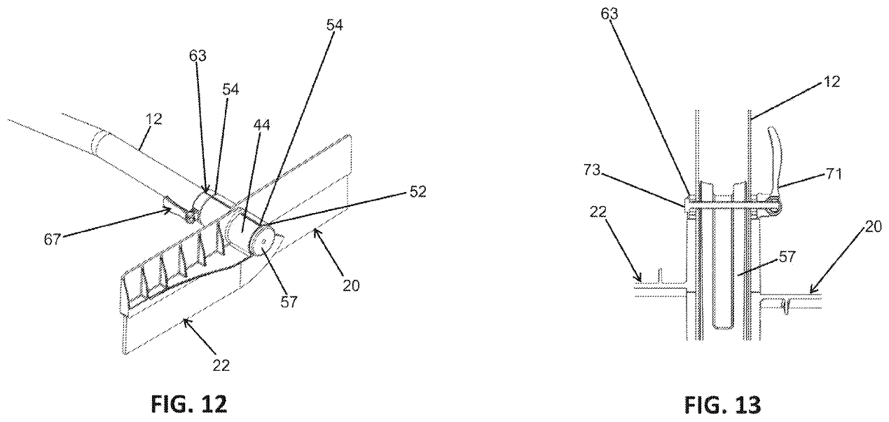

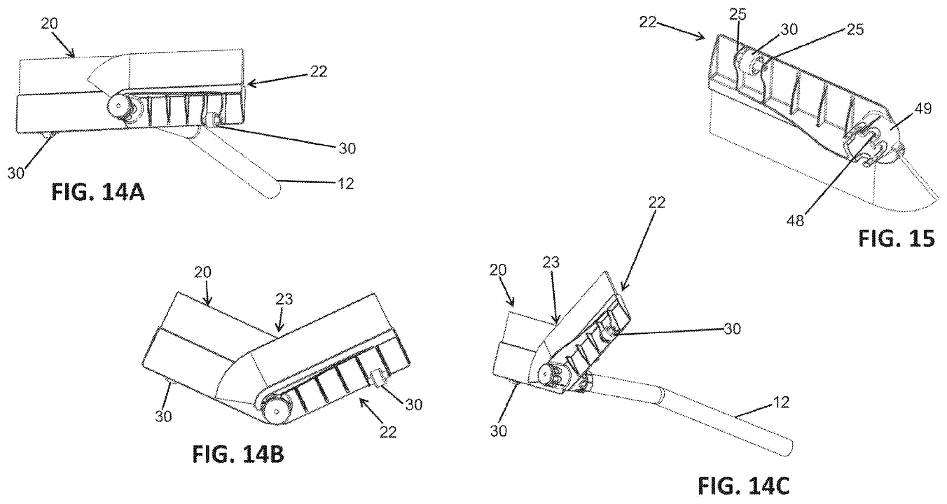

FIGS. 12 and 13 illustrate an alternative locking mechanism between the surface engaging utensil 20 and the end portion 14. In this embodiment, a movable member 63 herein shown as a collar, can slide on the end portion 14 toward the surface engaging utensil 20 when desired so as to fix the positions of the surface engaging utensils 20, 22 as described above. The collar 63 can have complementary surfaces the interlock with the complementary surfaces on collar 49 of surface engaging utensil 20. A fastener 67 selectively fixes the movable member 63 on the end portion so as to maintain the engagement of the collar 63 with surface engaging utensil 20, the surface engaging utensils 20, 22 together, and the surface engaging utensil 22 with the plug 57. In one embodiment the fastener 67 can comprise a cam 71 with a through bolt 73 to fix the position of movable member 63 when desired. FIGS. 16-22 illustrate different portions of a roof or gutter being cleaned by the cleaning apparatus 10 herein described. In FIG. 16 the apparatus 10 is being used to remove debris from a valley 73 between roof sections 74A and 74B of roof 11. It is noted that the surface engaging utensils 20, 22 are formed in a V-shape that is complimentary to the valley 73

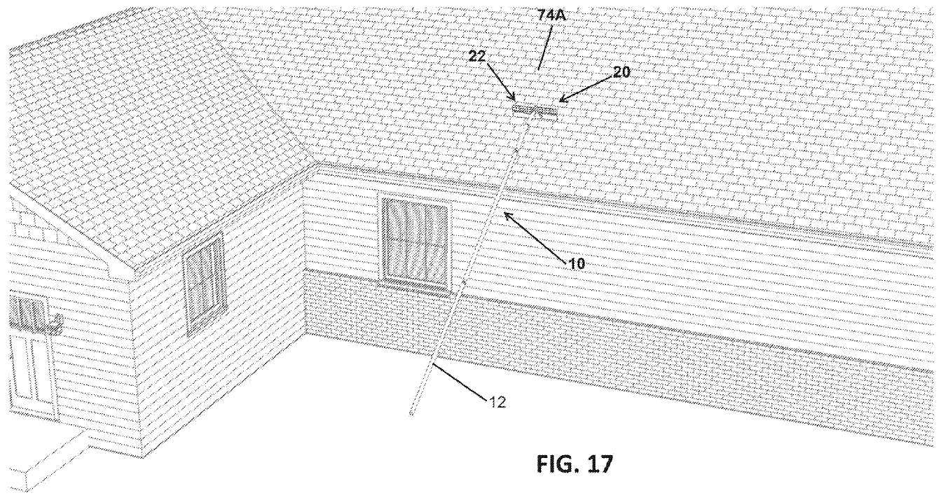

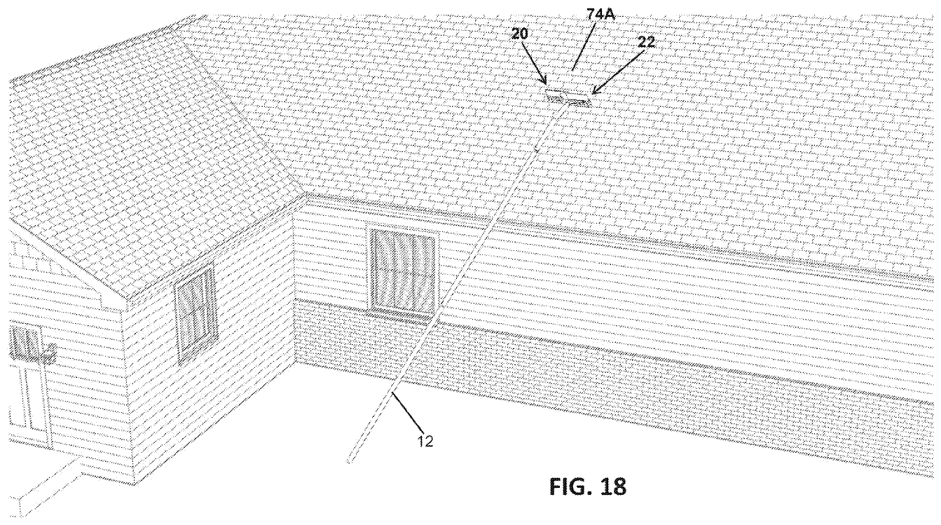

In FIG. 17, the apparatus 10 is removing debris from the flat surface of the roof section 74A wherein the surface engaging utensils 20, 22 extend in opposite directions. In FIG. 17 the first radially extending edges 20A, 22A such as with bristles contact the roof, while in FIG. 18 the rigid radially extending edge portions 20B, 22B function as a scraper upon roof section 74A.

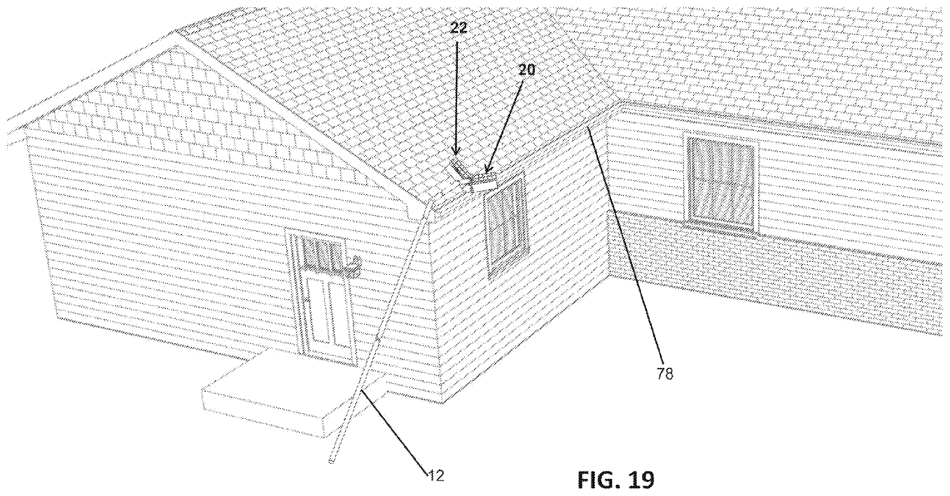

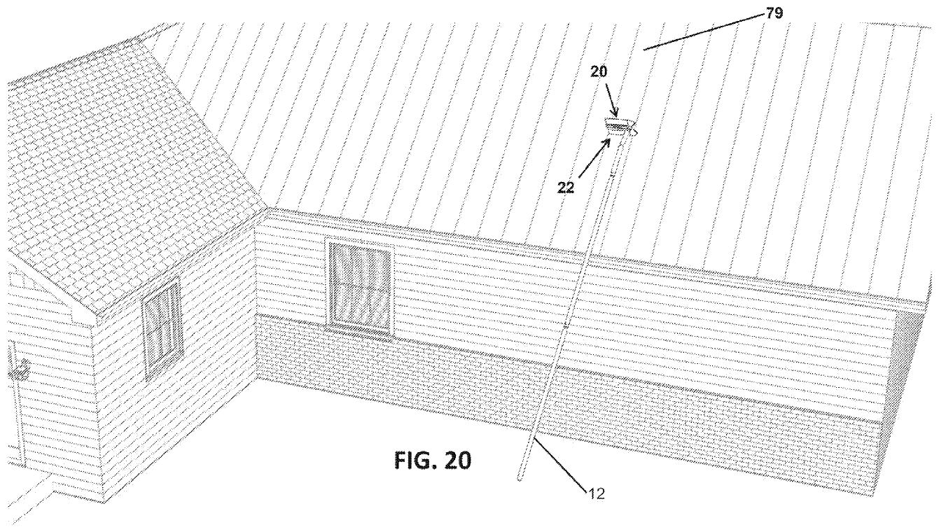

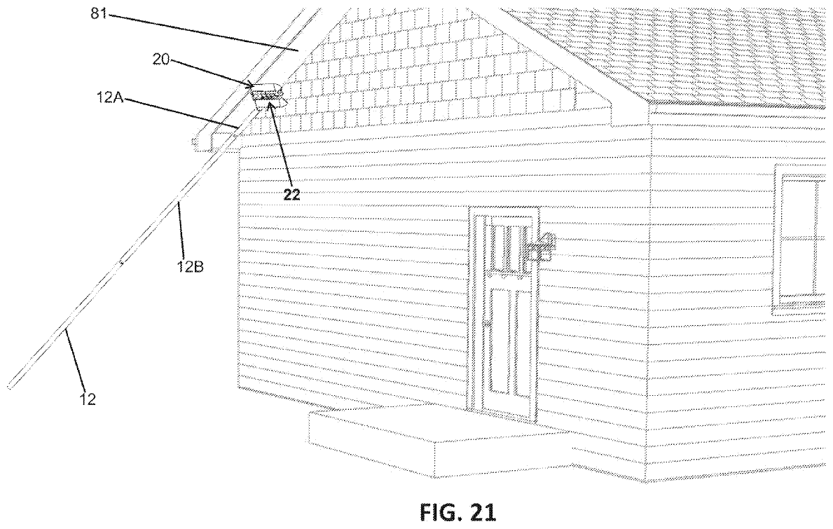

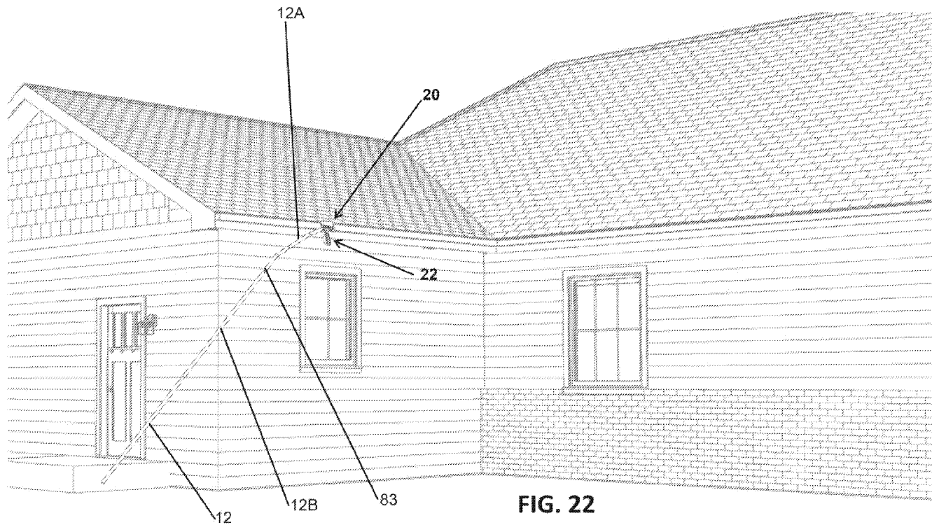

In FIG. 19 the surface engaging utensils are in a V-shape so as to clean a gutter 78, while in FIG. 20, the surface engaging utensils are stacked upon each other and are parallel to each other such as what might be desired cleaning a steel roof 79. The same configuration with the surface engaging surfaces stacked upon each other can be used to clean the soffit 81 as illustrated in FIG. 21 or arranged in a V-shape illustrated in FIG. 22 to engage portions of the soffit 81 and portions of the siding 83 at the same time.

It should be noted that the pole 12 is commonly formed of separate selectively fixable portions so as to obtain a desired length. However, it should also be noted that the portion of the pole 12 having the end portion 14 can be selectively oriented at a desired angle with respect to the second to the last section of the pole 12 so as to form a desired angle which may allow the apparatus 10 to be in a proper position for the user to engage the desired surfaces to be cleaned in view of their location on the ground. For example, in FIG. 21 end portion 12A extends from end portion 12B and is parallel with longitudinal axes generally considered aligned with each other. In FIG. 22, end portion 12A extends from end portion 12B in an offset manner where the longitudinal axes are not aligned with each other but rather intersect with each other.

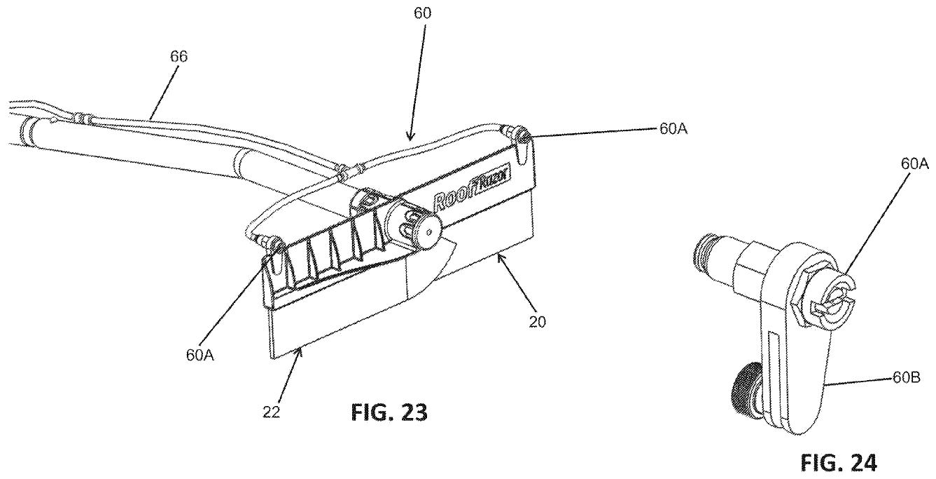

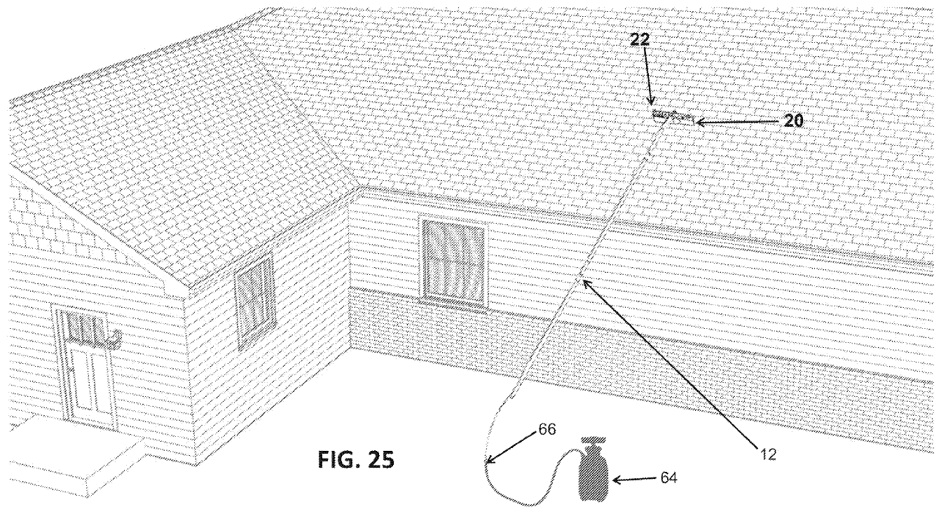

FIGS. 23-25 illustrate a nozzle assembly that can be selectively and removably attached to the surface engaging utensils 20, 22. In the embodiment illustrated, a nozzle 60A has a clamping member 60B that can be clamped upon the rigid portion of the surface engaging utensil 20, 22. A tubing system 66 extends from the nozzles 60A to a pump 64 herein illustrated as a hand pump in FIG. 25 but could be a motor operated pump. The pump 64, tubing system 66 and nozzle(s) 60A and/or 60B can be used to spray liquid upon surfaces such as but not limited to water proofing the surfaces, providing a fungicide, or providing a liquid that controls moss and algae. Soaps, bleaches and deicing liquids can also be applied to the surface with the pump 64 and tubing system 66 and nozzle(s) 60A and/or 60B.

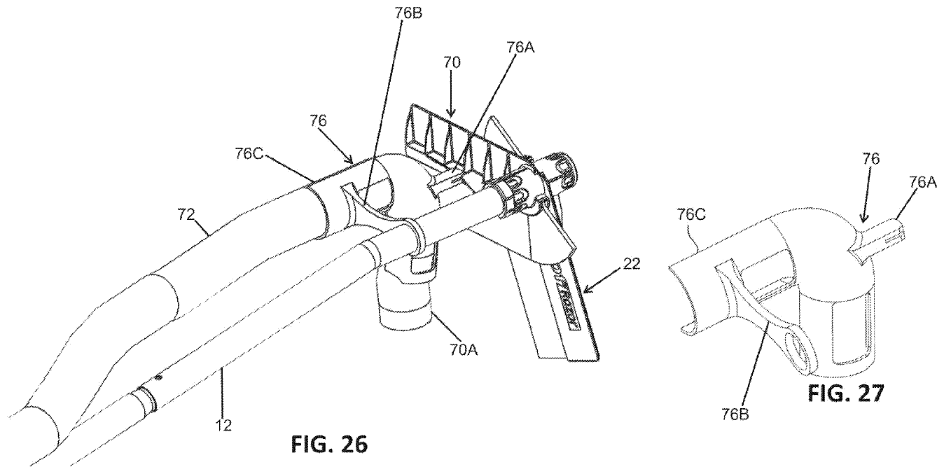

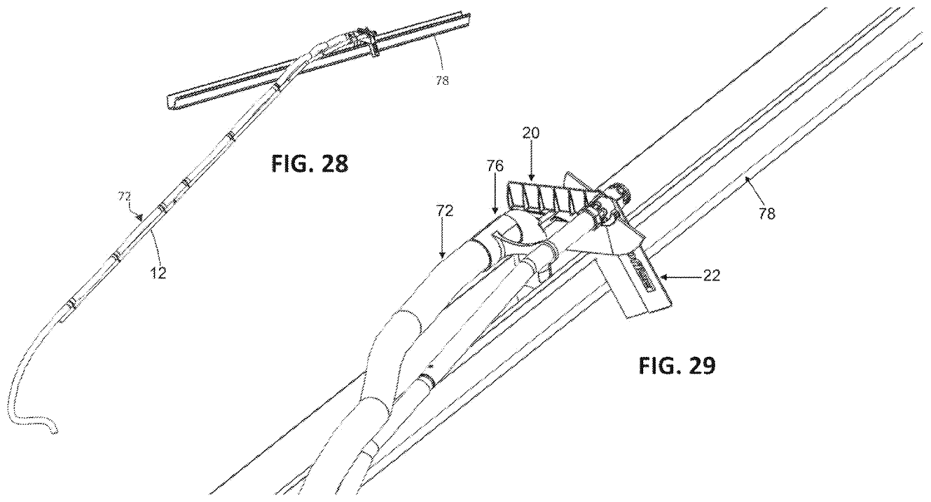

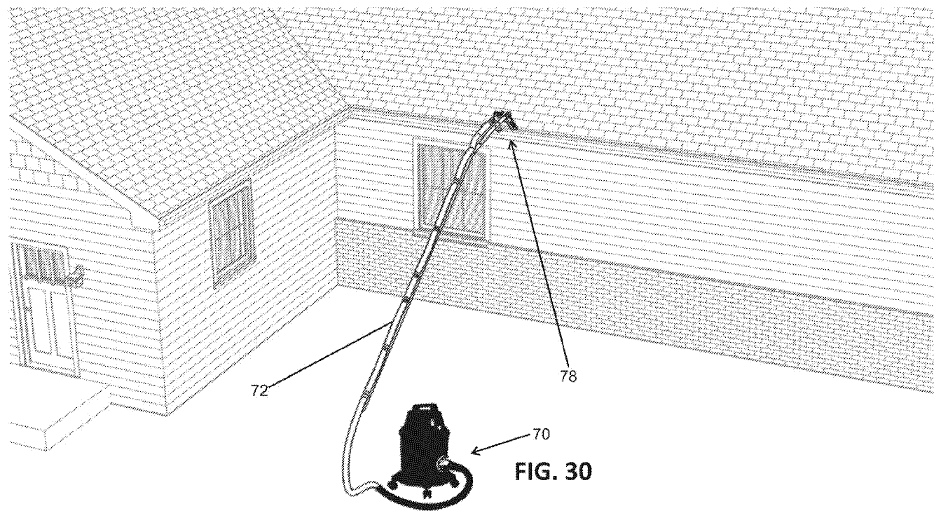

FIGS. 26-30 illustrate a vacuum system 70 that can be mounted to the end portion 14 which can be used to remove debris such as in a gutter 78. Generally, the vacuum system 70 includes a vacuum 74 illustrated in FIG. 30 with tubing 72 connected thereto and to pole 12 to form a lightweight flexible duct 72 having a nozzle 70A. The nozzle 70A is held to the pole 12 and end portion 14 with a support 76 herein having a support arm 76B joined to pole 12 and a shell 76C that engages tubing 72. If desired, the support 76 can include a portion 76A that can engage the rigid portion of the surface engaging utensil 20 so as to hold the angular position of the nozzle 70A in a fixed position. As illustrated in FIG. 26, the surface engaging utensils 20, 22 can be configured in a V-shape so as to guide the nozzle 70A along the gutter 78 as illustrated in FIG. 29.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

1. A surface cleaning apparatus comprising:
an elongated pole having a longitudinal axis extending along an end portion remote from an opposite end; and
a first surface engaging utensil and a second surface engaging utensil each being joined to the end portion, wherein each of the first surface engaging utensil and the second surface engaging utensil extends radially with respect to the longitudinal axis from the end portion, and wherein at least one of the first surface engaging utensil and the second surface engaging utensil is rotatable about the longitudinal axis and adjustably fixable at a plurality of different angular positions with respect to the end portion.

2. The surface cleaning apparatus of claim 1, wherein each of the first surface engaging utensil and the second surface engaging utensil includes a first radially extending edge portion and a second radially extending edge portion on a side opposite the first radially extending edge portion, wherein the at least one of the first surface engaging utensil and the second surface engaging utensil is rotatable about the longitudinal axis so as to selectively orient the first surface engaging utensil and the second surface engaging utensil in a first V-shape and a second V-shape, wherein in the first V-shape, the first radially extending edge portions face toward each other forming an inner acute angle, and wherein in the second V-shape, the second radially extending edge portions face toward each other forming the inner acute angle.

3. The surface cleaning apparatus of claim 2, wherein the first radially extending edge portions are flexible.

4. The surface cleaning apparatus of claim 2, wherein the second radially extending edge portions comprise a rigid and/or semi-rigid scraper.

5. The surface cleaning apparatus of claim 4, wherein a glide or wheel is attached to the rigid and/or semi-rigid scraper to space apart the second radially extending edge portion from a surface upon which the glide or wheel engages.

6. The surface cleaning apparatus of claim 2, wherein the at least one of the first surface engaging utensil and the second surface engaging utensil is rotatable such that in a first position the first radially extending edge portions are selectively fixed adjacent to and substantially parallel to each other, and in a second position the second radially extending edge portions are selectively fixed adjacent to and substantially parallel to each other.

7. The surface cleaning apparatus of claim 3, wherein at least one of the first surface engaging utensil and the second surface engaging utensil are flexible proximate the pole that extend to form an apex in the first V-shape.

8. The surface cleaning apparatus of claim 7, wherein first surface engaging utensil and the second surface engaging utensil form a substantially continuous length of one or more strips, foams, and/or bristles along the first surface engaging utensil, through the apex and along the second surface engaging utensil.

9. The surface cleaning apparatus of claim 8, wherein the substantially continuous length of the one or more strips, foams and/or bristles along the first surface engaging utensil, through the apex and along the second surface engaging utensil is provided for a plurality of V-shapes with different acute angles between the first surface engaging utensil and the second surface engaging utensil.

10. The surface cleaning apparatus of claim 1 and a pole-based lock operable between the at least one of the first surface engaging utensil and the second surface engaging utensil and the end portion to hold the at least one of the first surface engaging utensil and the second surface engaging utensil in selected angular positions with respect to the end portion.

11. The surface cleaning apparatus of claim 1 and a utensil lock operable between the first surface engaging utensil and the second surface engaging utensil to hold the at least one of the first surface engaging utensil and the second surface engaging utensil in selected angular positions with respect to the end portion.

12. The surface cleaning apparatus of claim 1, wherein each of the first surface engaging utensil and the second surface engaging utensil are rotatable about the longitudinal axis and adjustably fixable at a plurality of different angular positions with respect to the end portion.

13. The surface cleaning apparatus of claim 12 and further comprising:
a utensil lock operable between the first surface engaging utensil and the second surface engaging utensil to hold the first surface engaging utensil and the second surface engaging utensil in selected angular positions with respect to the end portion; and
a pole-based lock operable between the first surface engaging utensil and the end portion to hold the first surface engaging utensil in selected angular positions with respect to the end portion.

14. The surface cleaning apparatus of claim 12 and further comprising:
a first pole-based lock operable between the first surface engaging utensil and the end portion to hold the first surface engaging utensil in selected angular positions with respect to the end portion; and
a second pole-based lock operable between the second surface engaging utensil and the end portion to hold the second surface engaging utensil in selected angular positions with respect to the end portion.

15. (canceled)

16. (canceled)

17. The surface cleaning apparatus of claim 11, wherein each utensil lock comprises complementary mating surfaces formed on the first surface engaging utensil and the second surface engaging utensil.

18. The surface cleaning apparatus of claim 1, wherein the first surface engaging utensil is identical to the second surface engaging utensil.

19. The surface cleaning apparatus of claim 1 and further comprising:
at least one nozzle joined to at least one of the first surface engaging utensil and the second surface engaging utensil;
a sprayer; and
a fluid line coupled at a first end to the at least one nozzle and coupled to the sprayer at a second end.

20. (canceled)

21. The surface cleaning apparatus of claim 1 and further comprising:
a vacuum nozzle joined to at least one of the end portion, the first surface engaging utensil and the second surface engaging utensil; and
a vacuum line connected to the vacuum nozzle.

22. The surface cleaning apparatus of claim 1, wherein the longitudinal axis of the end portion intersects with a second longitudinal axis of a portion of pole joined to the end portion.

23. (canceled)

24. The surface cleaning apparatus of claim 1, wherein the elongated pole comprises a plurality of sections selectively connectable together to obtain a desired length of the pole, at least one of the sections including a soft outer covering.
